(19) United States
(12) Patent Application Publication
(10) Pub. No.: US 2013/0024846 A1
(43) Pub. Date: Jan. 24, 2013

(54) Real-Time Code Coverage Results in AD-HOC Testing

(71) Applicants: Micah Lewis, Issaquah, WA (US); Adrian Smarandoiu, Kirkland, WA (US); Jack Niewiadomski, Redmond, WA (US); John Hoegger, Duvall, WA (US)

(72) Inventors: Micah Lewis, Issaquah, WA (US); Adrian Smarandoiu, Kirkland, WA (US); Jack Niewiadomski, Redmond, WA (US); John Hoegger, Duvall, WA (US)

(73) Assignee: Microsoft Corporation, Redmond, WA (US)

(21) Appl. No.: 13/188,489

(22) Filed: Jul. 22, 2011

(51) Int. Cl. G06F 9/44

(52) U.S. Cl. 717/130

(57) ABSTRACT

Code coverage may be provided. First, coverage data and static data may be received. Next, results may be created based on the received coverage data and the received static data. The results may then be displayed.

### BACKGROUND

Software testers have limited time to verify changes introduced by developers throughout the product cycle. With large, complex software products, it is difficult to target changes and verify that tests are exercising the changed code with the time available. At best, testers perform black box testing without ever examining the actual code changes and verifying they are executed. As a result, decisions regarding whether to accept or reject the changes after testing are frequently based on a gut feel.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Code coverage may be provided. First, coverage data and static data may be received. Next, results may be created based on the received coverage data and the received static data. The results may then be displayed.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of a testing system;

FIG. 2 is a block diagram of a computing device;

FIG. 3 is a flow chart of a method for providing code coverage;

FIG. 4 is a block diagram of a system including the computing device; and

FIG. 5 is a block diagram of a mobile computing environment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Real-time code coverage results in ad-hoc testing may be provided. Code coverage is a software metric that may be used to identify code that was or was not executed during test runs. Code coverage has not been used as a feedback mechanism to direct software testing efforts during ad-hoc testing. Consistent with embodiments of the present invention, an up-to-date view of code coverage may be provided for a software product under test by regularly combining previously derived static information for a binary with a compact representation of executed code.

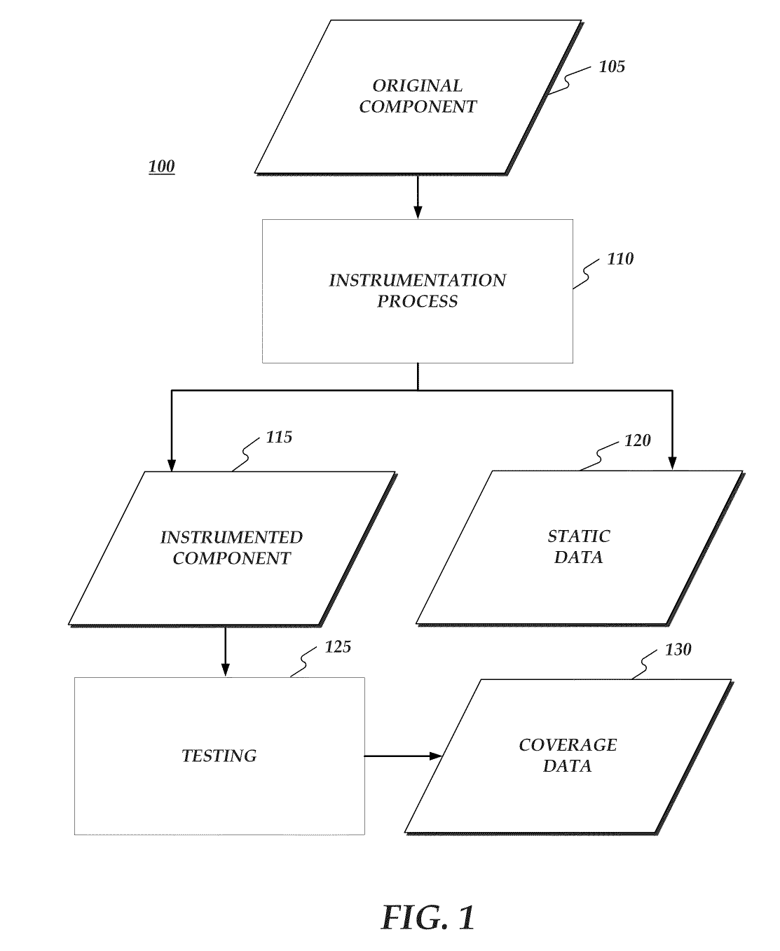

FIG. 1 is a block diagram of a testing system 100. As shown in FIG. 1, a binary (e.g. an original component 105) to be tested may undergo an instrumentation process 110 to create an instrumented binary (e.g. instrumented component 115). Original component 105, may comprise, but is not limited to, a portable executable binary or a script file. During instrumentation process 110, code markers (e.g. test markers) may be injected into the binary that may identify when blocks of code in the binary are executed. During instrumentation process 110, static data 120 may be saved to a binary blob that may contain a mapping between the injected code markers and source code corresponding to the binary.

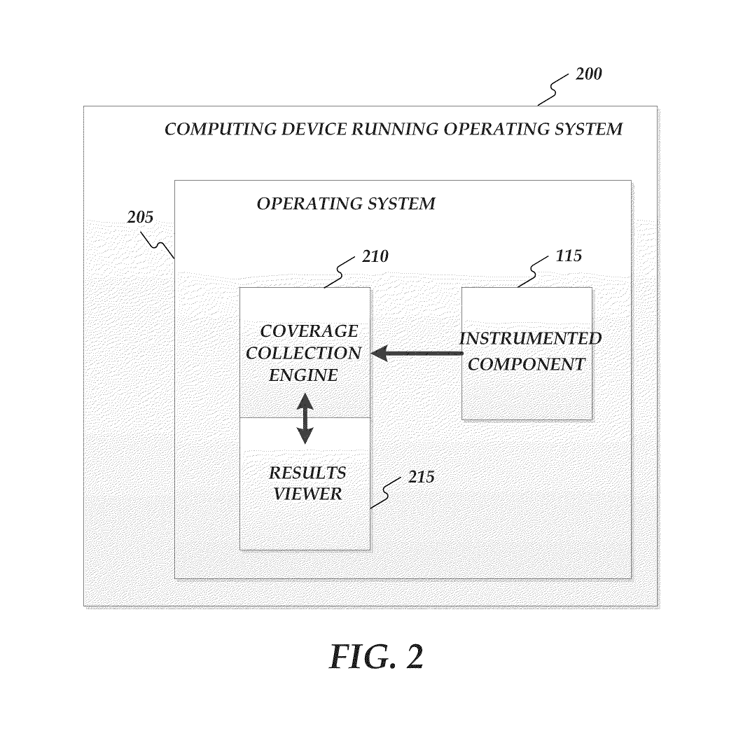

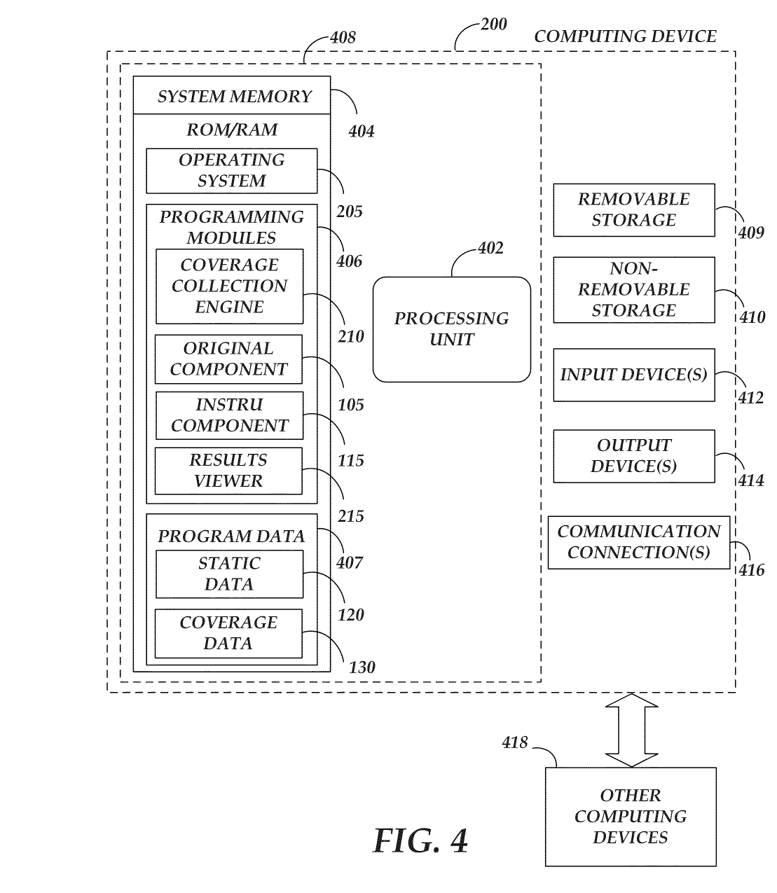

FIG. 2 is a block diagram of a computing device 200 that is described in greater detail below with respect to FIG. 4. As shown in FIG. 2, computing device 200 may include an operating system 205, a coverage collection engine 210, and a results viewer 215. When the instrumented binary is executed during an ad-hoc test run (e.g. testing 125), coverage data 130 on which code markers have executed may be buffered in memory of computing device 200. Coverage collection engine 210 may regularly combine coverage data 130 with static data 120 to identify which lines of source code have executed during the test run of the instrumented binary.

A regularly (e.g. every few seconds) refreshed view of the source code may be displayed to a user by results viewer 215. The regularly refreshed view may be annotated to show code lines from the source code highlighted to indicate that the highlighted code has been executed during the ad-hoc test run. Consequently, real-time code coverage data 130 may be used to direct test case identification in ad-hoc testing. During ad-hoc testing, an annotated view of the source code may be updated regularly to reflect the latest code coverage results.

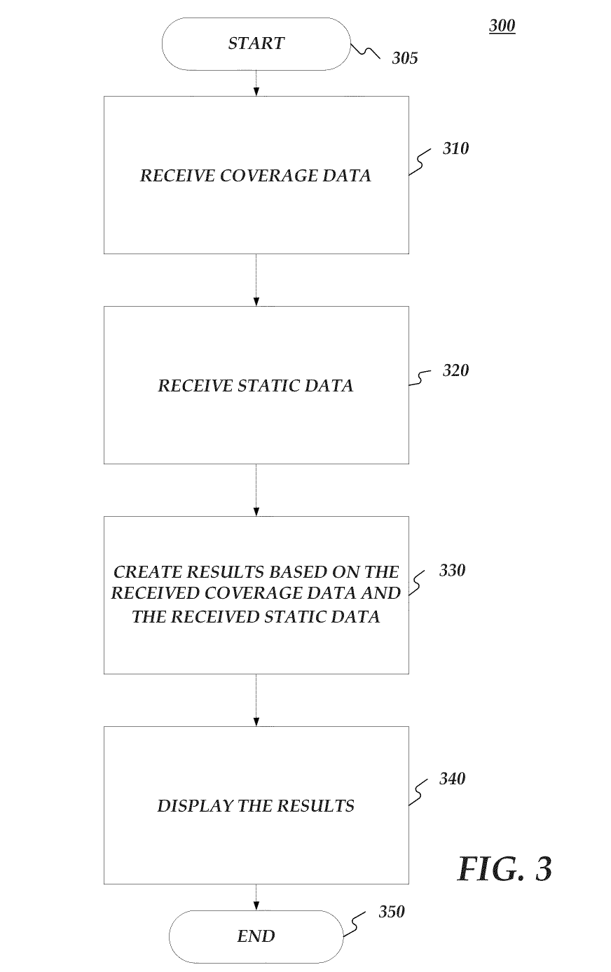

FIG. 3 is a flow chart setting forth the general stages involved in a method 300 consistent with an embodiment of the invention for providing code coverage. Method 300 may be implemented using computing device 200 as described in more detail below with respect to FIG. 4. Ways to implement the stages of method 300 will be described in greater detail below.

Method 300 may begin at starting block 305 and proceed to stage 310 where computing device 200 may receive coverage data 130. For example, as described above with respect to instrumentation process 110, instrumented component 115 may be created by placing at least one test marker in original component 105. The test marker may correspond to a block in instrumented component 115. The block may comprise a sequence of instructions in instrumented component 115 having a single entry point and a single exit point.

Once instrumented component 115 has been created, coverage data 130 may be created. Coverage data 130 may be created in response to performing a test run of instrumented component 115. For example, a user may execute instrumented component 115 on computing device 200. When executing instrumented component 115, the user may carry out a sequence of functions within instrumented component 115 with the goal of seeing which lines in source code corresponding to instrumented component 115 were executed when the user carried out the aforementioned sequence of functions.

Consistent with embodiments of the invention, when the user carried out the aforementioned sequence of functions, at least one test marker may have been passed in instrumented component 115 when instrumented component 115 was executed during the test. In response to at least one test marker being passed, an element in a memory array in the memory of computing device 200 may have been set to “1”. The aforementioned element in the memory array may correspond to at least one test marker. Accordingly, coverage data 130 may be received, for example, from the aforementioned memory array in this manner. In other words, coverage collection engine 210, running on computing device 200, may collect coverage data 130 from the memory array in computing device 200, for example, every few seconds.

From stage 310, where computing device 200 receives coverage data 130, method 300 may advance to stage 320 where computing device 200 may receive static data 120. For example, during instrumentation process 110, test markers may be injected (e.g. into original component 105 to create instrumented component 115) that may identify when blocks of code in instrumented component 115 are executed. During instrumentation process 110, static data 120 may be saved on computing device 200 that may contain a mapping between the injected test markers and source code corresponding to instrumented component 115. In other words, static data 120 may be used to map at least one code line in the source code (corresponding to original component 105) to at least one test marker in instrumented component 115.

Once computing device 200 receives static data 120 in stage 320, method 300 may continue to stage 330 where computing device 200 may create results based on received coverage data 130 and the received static data 120. For example, the results may indicate at least one code line, in source code corresponding to original component 105, passed during the aforementioned test run of instrumented component 115. Moreover, the results may indicate other code lines, in source code corresponding to original component 105, not passed during the test run. In other words, coverage collection engine 210 may regularly combine coverage data 130 with static data 120 to identify which lines of source code corresponding to original component 105 have executed during the test run of instrumented component 115.

After computing device 200 creates the results in stage 330, method 300 may proceed to stage 340 where computing device 200 may display the results. For example, results viewer 215 may regularly (e.g. every few seconds) display, on a display connected to computing device 200, a refreshed view of the source code. The display may comprise one of a number of output devices 412 described below. The regularly refreshed view may be annotated to show code lines from the source code highlighted to indicate that the highlighted code has been executed during the test run.

After viewing the results, the user may carry out yet another sequence of functions within instrumented component 115 with the goal of seeing which lines in source code corresponding to instrumented component 115 were executed when the user carried out the yet another sequence of functions. Consequently, real-time code coverage data 130 may be used for direct test case identification in ad-hoc testing. During ad-hoc testing, an annotated view of the source code may be updated regularly to reflect the latest code coverage results. Once computing device 200 displays the results in stage 340, method 300 may then end at stage 350.

An embodiment consistent with the invention may comprise a system for providing code coverage. The system may comprise of memory storage and a processing unit coupled to the memory storage. The processing unit may be operative to receive coverage data and to receive static data. The processing unit may be further operative to create results based on the received coverage data and the received static data and to display the results.

Another embodiment consistent with the invention may comprise a system for providing code coverage. The system may comprise of memory storage and a processing unit coupled to the memory storage. The processing unit may be operative to collect coverage data in response to a test run of an instrumented component. The coverage data may indicate at least one test marker in the instrumented component passed during the test run of the instrumented component. Moreover, the processing unit may be operative to create results based on the collected coverage data and static data. The static data may indicate at least one code line in an original component. The static data may correspond to at least one test marker in the instrumented component corresponding to the original component. In addition, the processing unit may be operative to display the results. The results may indicate: i) at least one code line, in the original component, passed during the test run of the instrumented component corresponding to the original component; and ii) other code lines, in the original component, not passed during the test run of the instrumented component corresponding to the original component.

Yet another embodiment consistent with the invention may comprise a system for providing code coverage. The system may comprise of memory storage and a processing unit coupled to the memory storage. The processing unit may be operative to execute a test run of an instrumented component. In addition, the processing unit may be operative to collect coverage data indicating at least one test marker passed during the test run of the instrumented component. The test marker may correspond to a block in the instrumented component. The block may comprise a sequence of instructions in the instrumented component having a single entry point and a single exit point. In addition, the processing unit may be operative to collect static data indicating at least one code line in an original component. The static data may correspond to at least one test marker in the instrumented component corresponding to the original component. Furthermore, the processing unit may be operative to create results based on the received coverage data and the received static data and to display the results indicating at least one code line.

FIG. 4 is a block diagram of a system including computing device 200 described above with respect to FIG. 2. Consistent with an embodiment of the invention, the aforementioned memory storage and processing unit may be implemented in a computing device, such as computing device 200 of FIG. 4. Any suitable combination of hardware, software, or firmware may be used to implement the memory storage and processing unit. For example, the memory storage and processing unit may be implemented with computing device 200 or any other computing devices 418, in combination with computing device 200. The aforementioned system, device, and processors are examples and other systems, devices, and processors may comprise the aforementioned memory storage and processing unit, consistent with embodiments of the invention. Furthermore, computing device 200 may comprise an operating environment for system 100 as described above. System 100 may operate in other environments and is not limited to computing device 200.

With reference to FIG. 4, a system consistent with an embodiment of the invention may include a computing device, such as computing device 200. In a basic configuration, computing device 200 may include at least one processing unit 402 and system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 205, one or more programming modules 406, and may include program data 407. Operating system 205, for example, may be suitable for controlling computing device 200's operation. In one embodiment, programming modules 406 may include coverage collection engine 210, original component 105, instrumented component 115, and results viewer 215. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 200 may have additional features or functionality. For example, computing device 200 may also include additional data storage devices (removable and/or non-removable) such as, for example, magnetic disks, optical disks, or tape. Such additional storage is illustrated in FIG. 4 by a removable storage 409 and a non-removable storage 410. Computing device 200 may also contain a communication connection 416 that may allow device 200 to communicate with other computing devices 418, such as over a network in a distributed computing environment, for example, an intranet or the Internet. Communication connection 416 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 404, including operating system 205. While executing on processing unit 402, programming modules 406 (e.g. coverage collection engine 210, original component 105, instrumented component 115, and results viewer 215) may perform processes including, for example, one or more method 300's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Embodiments of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the invention, may be performed via application-specific logic integrated with other components of computing device 200 on the single integrated circuit (chip).

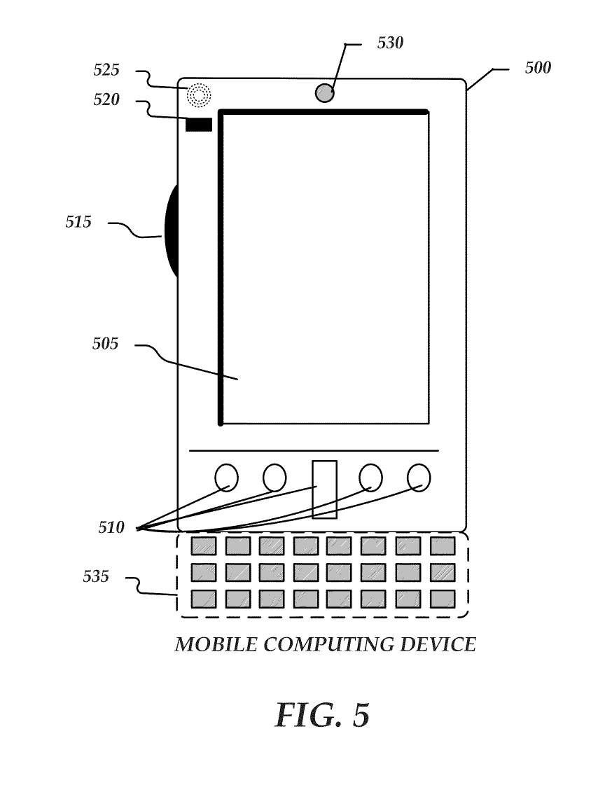

FIG. 5 illustrates a mobile computing environment, for example, a mobile telephone, a smartphone, a tablet personal computer, a laptop computer, and the like, with which embodiments of the invention may be practiced. Embodiments of the invention may be practiced via a mobile computing device 500 where each or many of the components illustrated in FIG. 4 may be integrated. In a basic configuration, mobile computing device 500 may be a handheld computer having both input elements and output elements. Input elements may include a touch screen display 505 and input buttons 510 that may allow a user to enter information into mobile computing device 500. Mobile computing device 500 may also incorporate a side input element 515 that may allow further user input. Side input element 515 may be a rotary switch, a button, or any other type of manual input element. In other embodiments, mobile computing device 500 may incorporate more or less input elements. For example, display 505 may not be a touch screen in some embodiments. In yet other embodiments, mobile computing device 500 may be a portable phone system, such as a cellular phone having display 505 and input buttons 510. Mobile computing device 500 may also include a keypad 535. Keypad 535 may be a physical keypad or a “soft” keypad generated on the touch screen display.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing code coverage, the method comprising:
receiving coverage data;
receiving static data;
creating results based on the received coverage data and the received static data; and
displaying the results.

2. The method of claim 1, wherein receiving the coverage data comprises receiving the coverage data in response to a test run of an instrumented component.

3. The method of claim 1, wherein receiving the coverage data comprises receiving the coverage data indicating at least one test marker in an instrumented component passed during a test run of the instrumented component.

4. The method of claim 1, wherein receiving the coverage data comprises receiving the coverage data indicating at least one test marker passed during a test run of an instrumented component, the test marker corresponding to a block in the instrumented component.

5. The method of claim 1, wherein receiving the coverage data comprises receiving the coverage data indicating at least one test marker passed during a test run of an instrumented component, the test marker corresponding to a block in the instrumented component, the block comprising a sequence of instructions in the instrumented component having a single entry point and a single exit point.

6. The method of claim 1, wherein receiving the coverage data comprises receiving the coverage data indicating at least one test marker passed during a test run of an instrumented component, the coverage data being received from a memory array having an element corresponding to the at least one test marker passed during the test run of the instrumented component.

7. The method of claim 1, wherein receiving the static data comprises receiving the static data indicating at least one code line in an original component, the static data corresponding to at least one test marker in an instrumented component corresponding to the original component.

8. The method of claim 1, wherein creating the results comprises creating the results indicating at least one code line, in an original component, passed during a test run of an instrumented component corresponding to the original component.

9. The method of claim 8, wherein creating the results comprises creating the results indicating other code lines, in the original component, not passed during the test run of the instrumented component corresponding to the original component.

10. The method of claim 1, wherein creating the results comprises creating the results indicating at least one code line indicated by the static data, the static data corresponding to at least one test marker in an instrumented component corresponding to an original component, the coverage data indicating the at least one test marker, in the instrumented component, passed during a test run of the instrumented component.

11. The method of claim 1, further comprising creating the coverage data.

12. The method of claim 11, wherein creating the coverage data comprises creating the coverage data in response to performing a test run of an instrumented component.

13. The method of claim 1, further comprising receiving an original component.

14. The method of claim 13, wherein receiving the original component comprises receiving the original component comprising a portable executable binary.

15. The method of claim 13, wherein receiving the original component comprises receiving the original component comprising a script file.

16. The method of claim 13, further comprising creating an instrumented component based upon the received original component.

17. The method of claim 16, wherein creating the instrumented component comprises placing at least one test marker in the original component, the test marker corresponding to a block in the instrumented component.

18. The method of claim 16, wherein creating the instrumented component comprises placing at least one test marker in the original component, the test marker corresponding to a block in the instrumented component, the block comprising a sequence of instructions in the instrumented component having a single entry point and a single exit point.

19. A computer-readable medium that stores a set of instructions which when executed perform a method for providing code coverage, the method executed by the set of instructions comprising:
collecting coverage data in response to a test run of an instrumented component, the coverage data indicating at least one test marker in the instrumented component passed during the test run of the instrumented component;
creating results based on the collected coverage data and static data, the static data indicating at least one code line in an original component, the static data corresponding to the at least one test marker in the instrumented component corresponding to the original component; and
displaying the results indicating;
the at least one code line, in the original component, passed during the test run of the instrumented component corresponding to the original component, and
other code lines, in the original component, not passed during the test run of the instrumented component corresponding to the original component.

20. A system for providing code coverage, the system comprising:
a memory storage; and
a processing unit coupled to the memory storage, wherein the processing unit is operative to:
execute a test run of an instrumented component;
collect coverage data indicating at least one test marker passed during the test run of the instrumented component, the test marker corresponding to a block in the instrumented component, the block comprising a sequence of instructions in the instrumented component having a single entry point and a single exit point;
receive static data indicating at least one code line in an original component, the static data corresponding to the at least one test marker in the instrumented component corresponding to the original component;
create results based on the received coverage data and the received static data; and
display the results indicating the at least one code line.
